(19) United States
(12) Patent Application Publication
(10) Pub. No.: US 2019/0163899 A1
(43) Pub. Date: May 30, 2019

(54) LOAD TIME ANTI-PROPAGATIONPROTECTION FOR A MACHINE ...

(71) Applicant: Hewlett-Packard Development Company, L.P., Houston, TX (US)

(72) Inventor: Nolan Letellier, Boise, ID (US)

(21) Appl. No.: 16/097,583

(22) PCT Filed: Jul. 29, 2016
(86) PCT No.: PCT/US2016/044870

§ 371 Date: Oct. 29, 2018

(51) Int. Cl. G06F 21/51; G06F 21/52

(52) U.S. Cl. CPC G06F 21/51; G06F 2221/033; G06F 21/52

(57) ABSTRACT

A technique includes providing anti-propagation protection for a machine executable module to be executed on a computer. Providing the anti-propagation protection includes, at a load time associated with the module, identifying predetermined units of the module and assigning locations for the units relative to each other in a memory of the computer. The locations are non-designated prior to the load time.

### BACKGROUND

A given computer may employ anti-propagation measures for purposes of inhibiting the propagation of a computer exploit (a worm, for example). In this manner, a computer exploit may rely on knowledge of the memory location of a process or function for purposes of writing data or instructions to the location to alter the behavior of the process or function for the benefit of the exploit. To counter such an attack, the computer may use address space layout randomization (ASLR) to obscure the locations of its processes and functions in memory.

### BRIEF DESCRIPTION OF THE DRAWINGS

FIG. 1 is a schematic diagram of a computer system that uses load time anti-propagation protection for executable modules according to an example implementation.

FIG. 2 is a schematic diagram of a computer system that processes an executable module to parse the module into relocatable sub-images according to an example implementation.

FIGS. 3 and 4 are flow diagrams depicting techniques to provide load time anti-propagation protection for a machine executable module according to example implementations.

### DETAILED DESCRIPTION

For purposes of providing anti-propagation protection, a computer system may load a given executable module into memory in a manner that inhibits a potential attacker from knowing or at least reliably predicting memory addresses that are associated with the module. In this context, an “executable module” may be any compilation of machine executable instructions, which is associated with a storage file name that identifies the compilation to the operating system. In addition to machine executable instructions, the executable module may contain other components, such as data structures (arrays, tables, variables, and so forth) and resources (bitmaps, user interfaces, and so forth). When loaded into the computer system's memory, the components of the executable module form a corresponding binary executable image.

As an example, a given executable module may be a dynamic link library (DLL) module (a file having a .DLL filename extension, for example), which provides functions, classes, resources, and so forth for an application or another DLL. In accordance with further example implementations, a given executable module may be a module other than a DLL module (an .EXE directly-executable module, for example).

The executable module may be initially stored in non-volatile file storage (a hard disk drive, persistent storage formed from non-volatile memory devices, and so forth), and the executable module may be made available to the computer system's memory during a phase called the module's “load time.” In this manner, during the load time for the executable module, the operating system “loads” the components of the module into memory from storage to form the binary executable image. As part of the loading of the module, the operating system may retrieve, or read, the components of the executable module from the non-volatile storage (a mass storage device, a persistent memory and so forth) and store, or write, data representing the machine executable code in the computer system's a physical memory (a dynamic random access memory (DRAM), for example). The loading of the executable module may not, however, involve writing to the physical memory, as the operating system may load a given executable module by allocating the memory locations for the machine executable module in a virtual memory system of the computer system.

The load time for the executable module precedes a phase called the “run time” for the module. The “run time” for the executable module refers to a phase in which the operating system executes machine executable instructions that are contained in the module's loaded binary image. In this manner, for the run time of the executable module, one or multiple microprocessor cores of the computer system retrieve instructions for the module from memory and execute the retrieved instructions to perform the operations and calculations that are identified by the instructions.

In accordance with example implementations, the loading of a given executable module may be located as part of an application, such that execution of the application does not begin until the module has been loaded. In this manner, the executable module may be a statically-linked DLL file. In accordance with further example implementations, the execution of a process may cause a given executable module to be loaded from storage. In this manner, the executable module may be a dynamically-linked DLL file. In general, in accordance with example implementations, the executable module may be a module that is loaded on demand, dynamically or not.

One way to prevent an attacker or exploit from knowing or at least reliably predicting memory addresses that are associated with an executable module is to randomly assign the base memory address of the module at load time. As a result, entire executable modules may be randomly distributed in memory. A potential challenge with this technique is that there may be a limited number of permutations for the base addresses of the executable modules, thereby presenting a relatively small pool of candidate address from which an attacker may potentially guess the address of a given executable module, or portion thereof.

Another way to randomize memory content is to, prior to load time, divide the executable image of a given executable module into sub-parts, or sub-images, and assign random addresses for these sub-images relative to the base address of the module. For example, a binary call tree analysis may be performed prior to the time at which the executable module is stored in the computer's file storage to identify the sub-images of the module and randomly assign addresses to these sub-images relative to the module's base address. In this manner, the binary call tree analysis parses, or subdivides, the module's executable image into the sub-images and determines entry and exit points (addresses point to by pointers, for example) for these sub-images. Using the results of the binary call tree analysis, the sub-images may then be distributed in memory according to the prearranged distribution. This precomputed randomization, however, is static for the life of the product. For purposes of achieving the anti-propagation benefits of code randomization for an installed fleet of products, each product instance may have its own precomputed randomized version. Although this technique may provide better randomization than the above-described randomization of entire executable modules, because the randomization is precomputed, the randomization may be potentially discovered by a potential attacker, which may design custom exploits for a fleet of products.

In accordance with example implementations that are described herein, the locations of sub-images for an executable module are randomized at load time. Therefore, computer exploits do not have knowledge regarding the randomization. Moreover, due to the randomization of the sub-images, a greater number of permutations exists, as compared to randomizing the locations of entire executable modules, thereby decreasing the probability that a computer exploit may guess the location of a given executable module, or portion thereof.

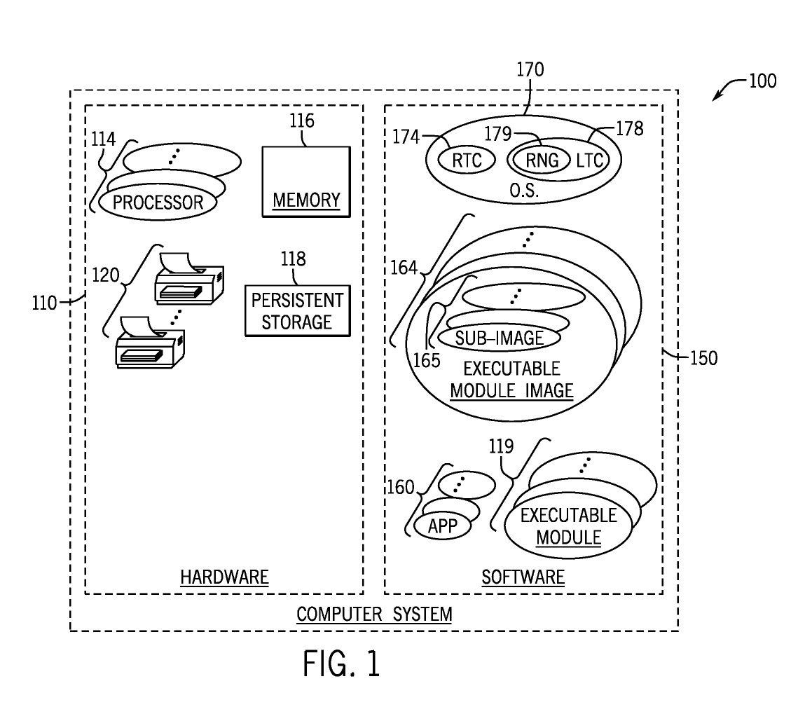

Referring to FIG. 1, as a more specific example, in accordance with some implementations, a computer system 100 stores one or multiple machine executable modules 119 in the form of files in non-volatile, or persistent, storage 118. A load time component 178 of an operating system 170 of the computer system 100 may load a given executable module 119 into memory in the form of an executable module image 164, which may then be executed by a run time component 174 of the operating system 170. In accordance with example implementations, loading the executable module image 164 into memory refers to allocating virtual memory addresses for the image 164.

As described herein, the executable module 119 may contain machine executable instructions and data, which represents the boundaries of the executable module image 164 to effectively parse the image 164 into relocatable sub-units, or sub-images 165. The executable module 119 may contain data that represents entry and exit points for each sub-image 165. In accordance with example implementations, using this information, the load time component 178, at load time, randomly assigns memory locations (virtual memory addresses for the base addresses of the sub-images 165, for example) to the sub-images 165 and adjusts references to the entry and exit points to reflect the randomly assigned memory locations. As such, the executable image 164 may be stored in a randomized distribution in several non-contiguous regions of memory.

For the purpose of randomly assigning the memory locations to the sub-images 165, the load time component 178 may contain a random number generator 179. In accordance with example implementations, a pool of virtual memory addresses may be available for allocation for the sub-images 165, and for each sub-image 165, the load time component 178 uses a random number (generated by the random number generator 179) to identify one of these virtual memory addresses as the base address for the sub-image 165.

In the context of this application, the random number that is generated by the random number generator 179 may be a truly randomly generated number (a number derived from randomly occurring natural phenomena, such as thermal noise or antenna-generated noise, as examples) or may be a near random, or “pseudo random,” number, which is machine generated. For example, in accordance with example implementations, the random number generator 179 may be a seed-based generator that provides a pseudo random output. As a more specific example, the random number generator 179 may be a polynomial-based generator, which provides an output that represents a pseudo random number, and the pseudo random number may be based on a seed value that serves as an input to a polynomial function. As examples, the seed value may be derived from a state or condition at the time the pseudo random number is generated, such as an input that is provided by a real time clock (RTC) value, a counter value, a register value, and so forth. In this manner, a polynomial-based generator may receive a seed value as an input, apply a polynomial function to the seed value and provide an output (digital data, for example), which represents a pseudo random number.

After randomly assigning the addresses for the sub-images 165, the load time component 178, in accordance with example implementations, may update references to entry and exit points of the sub-images 165 to reflect the randomly assigned memory locations. For example, in accordance with example implementations, the executable module 119 may contain entries called “fixups.” Each fixup is a pointer to and address whose memory content is to be updated based on the randomly assigned addresses of the sub-images 165. The fixups include pointers to addresses internal and external to the executable module image.

In accordance with some implementations, changing the content at an address that is identified by a fixup may involve substituting an address at the location with an updated address. Changing the content at an address that is identified by a fixup may involve inserting or modifying a jump instruction. Depending on the span of the redirection and the capability of the computer system 100, the load time component 178 may insert a direct or indirect jump. For example, for example implementations in which the computer system 100 supports branch instructions with a 32 bit offset, a direct jump may be used, but if the computer system 100 supports a 16 bit offset but not a 32 bit offset, then the load time component 178 may insert an indirect jump for offsets greater than 16 bits to get from the branch to the target code.

The executable module images 164, sub-images 165, operating system 170 and executable modules 119 are examples of software 150 of the computer system 100. In this context, “software” refers to machine executable instructions, data structures, resources, and so forth. The computer system 100 may also include various other software components, such as, for example, one or multiple applications 160.

In accordance with example implementations, one or multiple executable modules 119 may be DLL modules. For example, a given application 160 may contain machine executable instructions that cause one or multiple DLL modules that form part of the application 160 to be loaded before execution of the application 160 begins. As another example, the execution of a given application 160 may generate a system call to cause a DLL module that supports the application 160 to be dynamically loaded. As another example, one or more of the executable modules 119 may be DLL modules that serve as device drivers for printers 120 of the computer system 100; and these DLL modules may be loaded at boot up of the computer system 100. As another example, a user action (a user action to activate a graphical user interface (GUI) feature, for example) may cause a DLL module to be loaded.

The persistent storage 118 and the printers 120 are examples of hardware 110 of the computer system 100, in accordance with example implementations. The computer system 100 may include other hardware 110 such as, for example, one or multiple processors 114 (processor cores, for example), which execute the machine executable instructions of the software 150. In this manner, the processors 114 may execute machine executable instructions that are retrieved from a system memory 116, such as machine executable instructions for a given executable module during module's run time. In general, the memory 116 is a physical, non-transitory storage medium, which may be formed from semiconductor-based storage devices, memristors, phase change memory devices, and so forth. Moreover, the computer system 100 may include many other hardware components, such as display devices, a keyboard, a mouse, and so forth.

In accordance with example implementations, the computer system 100 may be contained in a single “box” or rack and be disposed at any one time a specific geographical location. In this manner, the computer system 100 may be, as examples, a portable computer, a tablet, a smartphone, a desktop computer, and so forth. However, in accordance with further example implementations, the computer system 100 may be geographically distributed at multiple geographic locations. For example, the hardware and/or software components of the computer system 100 may be distributed over a local area network (LAN), a wide area network (WAN), and so forth.

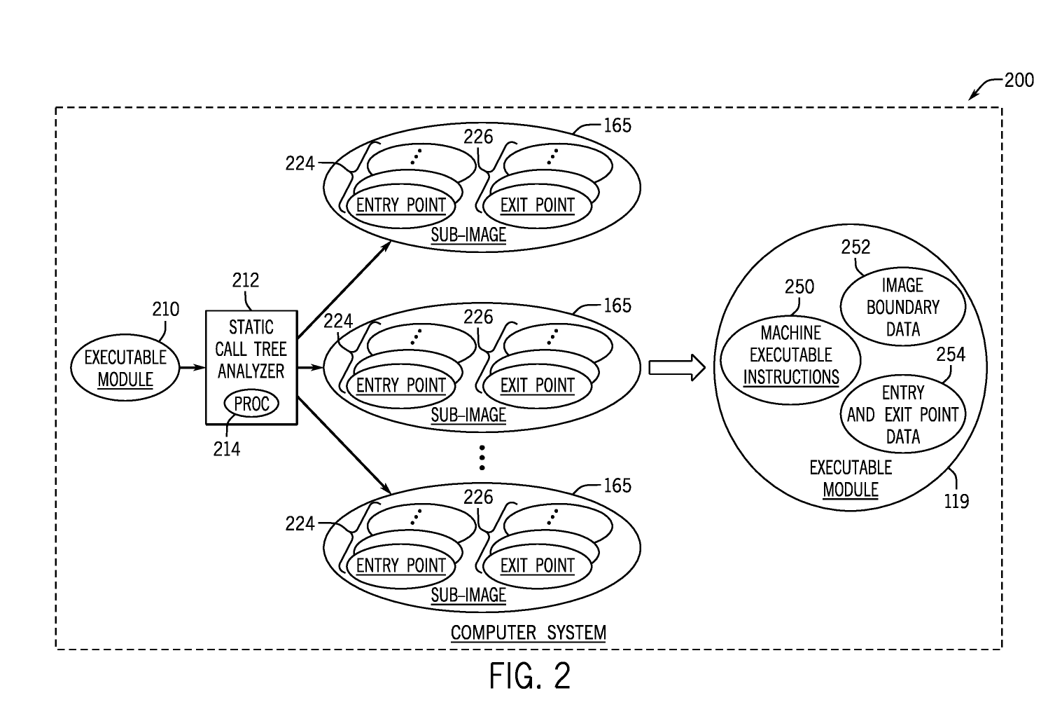

Referring to FIG. 2 in conjunction with FIG. 1, in accordance with some implementations, a computer system 200 may process a given executable module 210 (a DLL module, for example) for purposes of transforming the executable module 210 into the executable module 164 that contains relocatable sub-images 165. For this purpose, in accordance with example implementation, the computer system 200 may contain one or multiple processors, a memory, and so forth, similar to the computer system 100 of FIG. 1.

In general, the computer system 200 includes a static call tree analyzer 212, which contains a processor 214, to perform a static, call tree analysis of the executable module 210. In this context, a “static” call tree analysis refers to an analysis being applied to the machine executable instructions of the executable module 210, before the instructions are executed, as opposed to a dynamic call tree analysis being performed based on observed execution of the instructions.

In accordance with some implementations, the static call tree analyzer 212 may be a reverse assembly code analyzer, which receives compiled program instructions (in the form of the executable module 210) and performs a binary-to-assembly code conversion to first, convert the compiled code into assembly code and then analyze a call tree, or graph, constructed from the assembly code for purposes of identifying entry and exit points of the assembly code. For example, a given entry or exit point may be an address that is pointed to by a pointer. Using this analysis, the static call tree analyzer 212 may identify boundaries of the executable module 210, which may be used to divide the executable module 210 into the sub-images 165. In this regard, a given sub-image 165 may have one or multiple associated entry points and one or multiple associated exit points.

Thus, the analysis by the static call tree analyzer 212 produces, in accordance with example implementations, multiple sub-image 165, with each sub-image 165 containing one or multiple entry points 224 and one or multiple exit points 226. With this subdivision of the executable module 210, the static call tree analyzer 212 may then produce the executable module 164, which contains machine executable instructions 250 of the executable module 210, data 252 identifying the boundaries of the sub-images 165 (thereby, effectively parsing or segmenting the executable code 250) and data 254 identifying the entry and exit points, or addresses, for the sub-images 165.

Referring to FIG. 1 in conjunction with FIG. 2, in accordance with example implementations, the load time component 178 of the operating system 170 may, at load time, may construct a table of fixups, which identifying addresses whose associated memory content is to be updated to reflect the random address assignments. Using the information of the executable module 164, the load time component 178 may randomly assign addresses for the sub-images 165 and then perform the address relocation assignments, as described above.

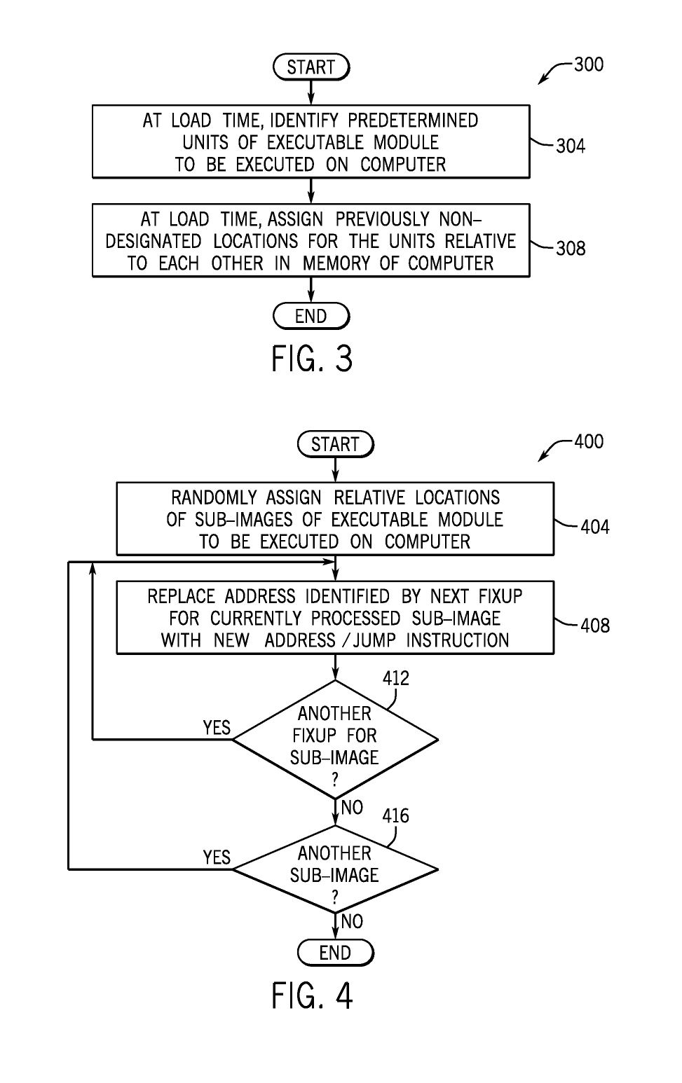

Referring to FIG. 3 in conjunction with FIG. 1, thus, in accordance with example implementations, a technique 300 to provide anti-propagation protection for a machine executable module to be executed on a computer includes, at load time, identifying (block 304) predetermined units of an executable module; and at load time, assigning (block 308) previously non-designated locations for the units relative to each other in a memory of the computer.

More specifically, referring to FIG. 4 in conjunction with FIG. 1, in accordance with example implementations, a technique 400 to provide anti-propagation protection of an executable module includes randomly (block 404) assigning relative locations of sub-images of the executable module. The technique 400 includes replacing (block 408) the content that is identified by the next fixup for the currently-processed sub-image with a new address or jump instruction. Pursuant to the technique 400, a determination is then made (decision block 412) whether another fixup for the currently-processed sub-image exists. If so, control returns to block 408. Otherwise, a determination is made (decision block 416) whether another sub-image of the executable module exists, and if so, control returns to block 408.

Other implementations are contemplated, which are within the scope of the appended claims. For example, in accordance with further example implementations, the load time component may combine sub-images from multiple executable modules and randomly assign the combination a memory address at load time.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
providing anti-propagation protection for a machine executable module to be executed on a computer, comprising, at a load time associated with the module:
identifying predetermined units of the module; and
assigning locations for the units relative to each other in a memory of the computer, the locations being non-designated prior to the load time.

2. The method of claim 1, wherein assigning the locations comprises randomly assigning the locations.

3. The method of claim 1, further comprising:
identifying a plurality of load time fixups for the units of the module.

4. The method of claim 3, further comprising:
replacing an address specified by executable code associated with a unit of the predetermined units, the address being associated with a fixup of the plurality of fixups.

5. The method of claim 3, further comprising:
replacing an address specified by executable code associated with a unit of the predetermined units with an indirect jump, the address being associated with a fixup of the plurality of fixups.

6. An article comprising a non-transitory computer readable storage medium to store instructions that when executed by a computer cause the computer to:
statically analyze machine executable instructions associated with a first executable module to determine a call tree of the executable module;
parse the first executable module into a plurality of sub-images and identify fixups associated with the plurality of sub-images based at least in part on the call tree; and
provide a second executable module comprising the sub-images, data representing the boundaries of the sub-images and data representing the fixups.

7. The article of claim 6, the storage medium storing instructions that when executed by the computer cause the computer to:
combine at least one other sub-image from at least one other execution module with at least one sub-image of the plurality of sub-images to provide the second execution module.

8. The article of claim 6, the storage medium storing instructions that when executed by the computer cause the computer to:
for a given sub-image of the plurality of sub-images, identify at least an entry point to the given sub-image based at least in part on the call tree.

9. An apparatus comprising:
an operating system comprising a hardware processor, a run time component and a load time component; and
a memory,
wherein:
the load time component loads an executable module to be executed by the run time component into the memory;
the load time component randomly assigns locations for sub-images of the executable module relative to each other in the memory; and
the load time component loads the sub-images into the randomly assigned locations of the memory.

10. The apparatus of claim 9, wherein the load time component retrieves data identifying the sub-images and fixups associated with the sub-images.

11. The apparatus of claim 9, wherein the executable module comprises a dynamic linking library (DLL) module or a module loaded on demand.

12. The apparatus of claim 9, wherein the load time component loads the sub-images into the memory in response to a bootup of the computer, in response to a user action, or in response to a system call.

13. The apparatus of claim 9, wherein the load time component
identifies load time fixups for the sub-images.

14. The apparatus of claim 9, wherein the load component replaces addresses associated with the fixups.

15. The apparatus of claim 9, wherein the load component replaces addresses associated with the fixups with indirect or direct jumps.
